(19) United States
(12) Patent Application Publication
(10) Pub. No.: US 2006/0237932 A1
(43) Pub. Date: Oct. 26, 2006

(54) Baby stroller

(76) Inventor: James E. Moore II, Indianapolis, IN (US)

Correspondence Address: Kyle S. Brant, 5441 Fenmore Road, Indianapolis, IN, 46228, US

(21) Appl. No.: 11/111,378

(22) Filed: Apr. 21, 2005

(51) Int. Cl. B62B 9/00

(52) U.S. Cl. 280/47.41

(57) ABSTRACT

A baby stroller with multiple wheels rotatably connected to a frame is disclosed. A seat is connected to the frame, and at least one arcuate transparent canopy is rotatably connected to the frame for shielding the baby.

### BACKGROUND OF THE INVENTION

1. Field of the Invention

The present invention relates to a baby stroller for use in connection with baby holding devices. The baby stroller has particular utility in connection with baby strollers having a retractable shield.

2. Description of the Prior Art

Baby strollers are desirable for transporting babies without having to carry them. Parents have activities which draw them out of their house, when these times arrive and a baby is present there are a few options, carry the baby in a carrier, hold the baby or use a stroller to push the baby around. Unfortunately there are times when parents are forced to take a baby out in inclement weather, either heat or cold, snow or rain. In these instances parents typically wrap the baby up in blankets. A need was felt for a stroller that could be taken out in inclement weather where the exposure of the baby is minimized, but the child can still see out.

The use of baby holding devices is known in the prior art. For example, U.S. Pat. No. 5,224,720 to Chaw et al discloses a stroller for a baby that includes a chair having a cover for shielding the same from sunshine and rain. The chair has a first and second recess respectively extending from a bottom and a front of the chair. A frame fixedly attached to the chair adjacent to its bottom has two ends carrying detachably a pair of rear wheels. The chair also has a pair of first toothed wheels respectively fixed on both sides of the chair adjacent its top portion and a foot rest extending from the front and having a third recess therethrough and in communication wit the second recess. A forked frame that includes two arms carrying a second wheel therebetween is inserted detachably into the second and third recesses. An inverted U-shaped frame is disposed on both sides of the chair that includes two arms, each with a second toothed wheel adapted to be meshed with the first toothed wheel such that he position of the inverted U-shaped frame can be altered relative to the back portion of the frame. However, the Chaw et al '720 patent does not have a plastic shield capable of surrounding the baby, does not have a telescoping seating area, and does not have telescoping legs.

Similarly, U.S. Pat. No. 5,076,599 to Lockett et al discloses a convertible stroller and trailer combination that can be changed from a stroller mode to a trailer mode and vice versa. When the vehicle is in either the stroller mode or trailer mode it includes a flexible seat for one or more passengers. When used in a stroller mode, rear wheels are attached to the opposite sides of the rear of the frame at a position called “position S” and front wheels are attached to the opposite sides of the front of the frame. At this position the load on the frame is distributed evenly on the rear wheels an on the front wheel. When the vehicle is in a trailer mode the front wheels are removed, the rear wheels are moved from the “position S” to a position forward and upward on the sides of the frame called “position T”. One end of a tow bar is attached to the front of the vehicle frame. Another end of the tow bar is attached to the rear of a towing vehicle, such as a bicycle frame. In the trailer mode the load on the frame is evenly distributed on the rear tires, while the front of the frame and tow bar carry very little load. However, the Lockett et al '599 patent does not have a plastic shield capable of surrounding the baby, does not have a telescoping seating area, and does not have telescoping legs.

Lastly, U.S. Pat. No. 2,971,796 to Morvai et al discloses a baby carriage that has a pair of parallel side wall structures, each side wall structure constituted by a pair of closely spaced inner and outer wall members. Each side wall structure having upstanding enlarged rear end portions with grooves respectively opening inwardly in opposed relation. A roll top constituted by a plurality of parallel bars pivotally secured to each other, said roll top slidably disposed in said grooves and providing a retractable hood for the carriage. One side wall structure having an opening extending through the wall members thereof. A stub shaft extending loosely through said opening and rotatably and slidably mounted therein. An elongated curved spring finger secured at one end to said stub shaft inside the wall structure, the other end of said spring finger adapted to engage said toll top for holding the same against movement. Means on the outer end of the stub shaft for moving said stub shaft for carrying said spring finger into and out of holding engagement with the roll top. Means associated with the stub shaft for preventing movement of the spring finger into holding engagement. However, the Morvai et al '796 patent does not have a plastic shield capable of surrounding the baby, does not have a telescoping seating area, and does not have telescoping legs.

While the above-described devices fulfill their respective, particular objectives and requirements, the aforementioned patents do not describe a baby stroller that allows baby strollers having a retractable shield. The Chaw et al '720, Lockett et al '599 and Morvai et al '796 patents make no provision for a plastic shield capable of surrounding the baby, do not have a telescoping seating area, and do not have telescoping legs.

Therefore, a need exists for a new and improved baby stroller that can be used for baby strollers having a retractable shield. In this regard, the present invention substantially fulfills this need. In this respect, the baby stroller according to the present invention substantially departs from the conventional concepts and designs of the prior art, and in doing so provides an apparatus primarily developed for the purpose of baby strollers having a retractable shield.

### SUMMARY OF THE INVENTION

In view of the foregoing disadvantages inherent in the known types of baby holding devices now present in the prior art, the present invention provides an improved baby stroller, and overcomes the above-mentioned disadvantages and drawbacks of the prior art. As such, the general purpose of the present invention, which will be described subsequently in greater detail, is to provide a new and improved baby stroller and method which has all the advantages of the prior art mentioned heretofore and many novel features that result in a baby stroller which is not anticipated, rendered obvious, suggested, or even implied by the prior art, either alone or in any combination thereof.

To attain this, the present invention essentially comprises multiple wheels rotatably connected to a frame. A seat is connected to the frame, and at least one arcuate transparent canopy is rotatably connected to the frame for shielding the baby.

There has thus been outlined, rather broadly, the more important features of the invention in order that the detailed description thereof that follows may be better understood and in order that the present contribution to the art may be better appreciated.

The invention may also include a handle, a footrest, a cup holder and telescoping legs. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved baby stroller that has all of the advantages of the prior art baby holding devices and none of the disadvantages.

It is another object of the present invention to provide a new and improved baby stroller that may be easily and efficiently manufactured and marketed.

An even further object of the present invention is to provide a new and improved baby stroller that has a low cost of manufacture with regard to both materials and labor, and which accordingly is then susceptible of low prices of sale to the consuming public, thereby making such baby stroller economically available to the buying public.

Still another object of the present invention is to provide a new baby stroller that provides in the apparatuses and methods of the prior art some of the advantages thereof, while simultaneously overcoming some of the disadvantages normally associated therewith.

Even still another object of the present invention is to provide a baby stroller having a retractable shield.

Still yet another object of the present invention is to provide a baby stroller having a telescoping seating area.

Lastly, it is an object of the present invention is to provide a baby stroller having telescoping legs.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front perspective view of the preferred embodiment of the baby stroller constructed in accordance with the principles of the present invention.

FIG. 2 is a top side view of the baby stroller of the present invention.

FIG. 3 is a front side view of the baby stroller of the present invention.

FIG. 4 is a section 4-4 view of FIG. 2 of the baby stroller of the present invention.

FIG. 5 is a section view of the baby stroller of the present invention.

FIG. 6 is a left side view of a second embodiment of the baby stroller of the present invention.

FIG. 7 is a back side view of a third embodiment of the baby stroller of the present invention.

The same reference numerals refer to the same parts throughout the various figures.

### DESCRIPTION OF THE PREFERRED EMBODIMENT

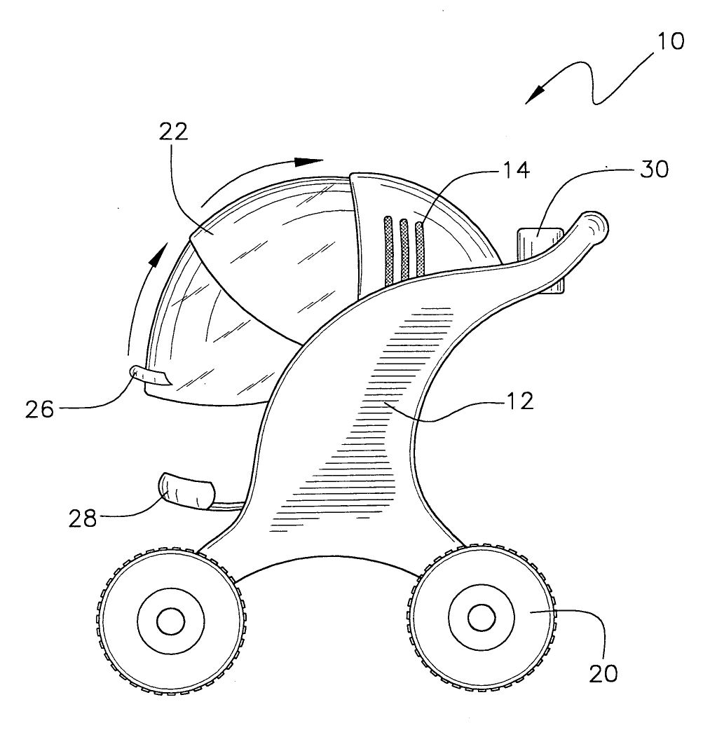

Referring now to the drawings, and particularly to FIGS. 1-7, a preferred embodiment of the baby stroller of the present invention is shown and generally designated by the reference numeral 10.

In FIG. 1, a new and improved baby stroller 10 of the present invention for baby strollers having a retractable shield is illustrated and will be described. More particularly, the baby stroller 10 a plurality of wheels 20 rotatably connected to a frame 12. At least one arcuate transparent canopy 22 is rotatably connected to the frame 12 for shielding the baby. A handle 26 is connected to the canopy 22 for raising and lowering the canopy 22. A foot rest 28 is connected to the frame 12. The frame 12 has an air vent slot 14 therein. At least one cup holder 30 is attached to the frame 12.

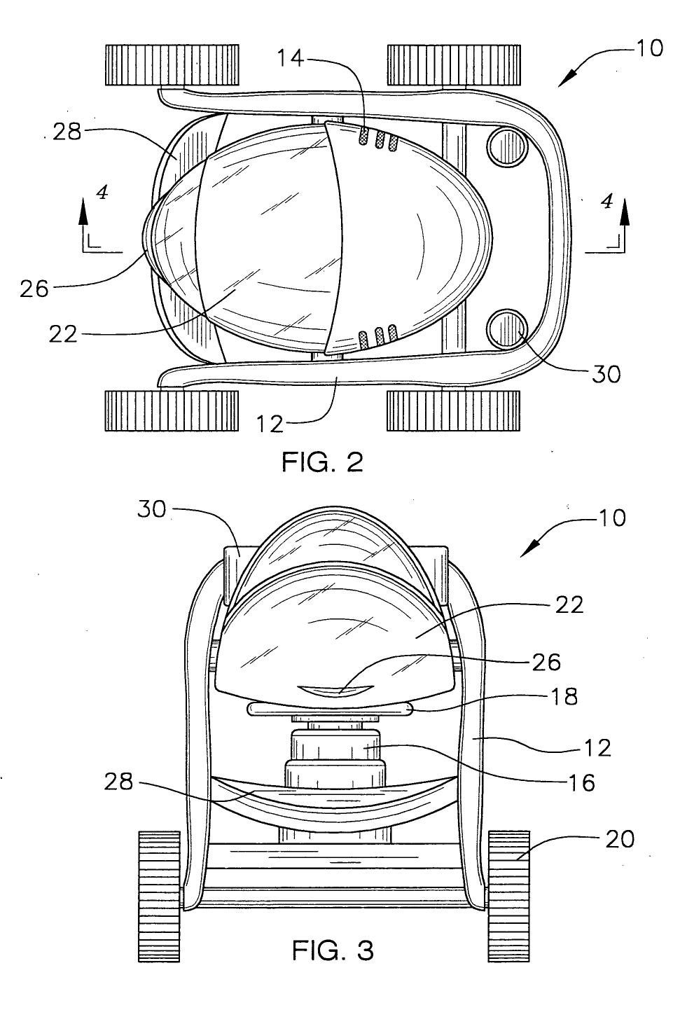

In FIG. 2, the baby stroller is illustrated and will be described. The baby stroller 10 the plurality of wheels 20 rotatably connected to the frame 12. The arcuate transparent canopy 22 is rotatably connected to the frame 12 for shielding the baby. The handle 26 is connected to the canopy 22 for raising and lowering the canopy 22. The foot rest 28 is connected to the frame 12. The frame 12 has the air vent slot 14 therein. The cup holder 30 is attached to the frame 12.

In FIG. 3, the baby stroller is illustrated and will be described. The baby stroller 10 has the frame 12 that has the air vent slot 14 therein. A seat 18 is connected to the frame 12. At least one telescoping seat cylinder 16 is connected to the frame 12. The telescoping seat cylinder 16 is lockable at predetermined lengths. The seat 18 is connected to the telescoping seat cylinder 16. The plurality of wheels 20 are rotatably connected to the frame 12. The oblate spheroid wedge shaped transparent canopy 22 is rotatably connected to the frame 12 for shielding the baby. The handle 26 is connected to the canopy 22 for raising and lowering the canopy 22. The foot rest 28 is connected to the frame 12. The cup holder 30 is attached to the frame 12.

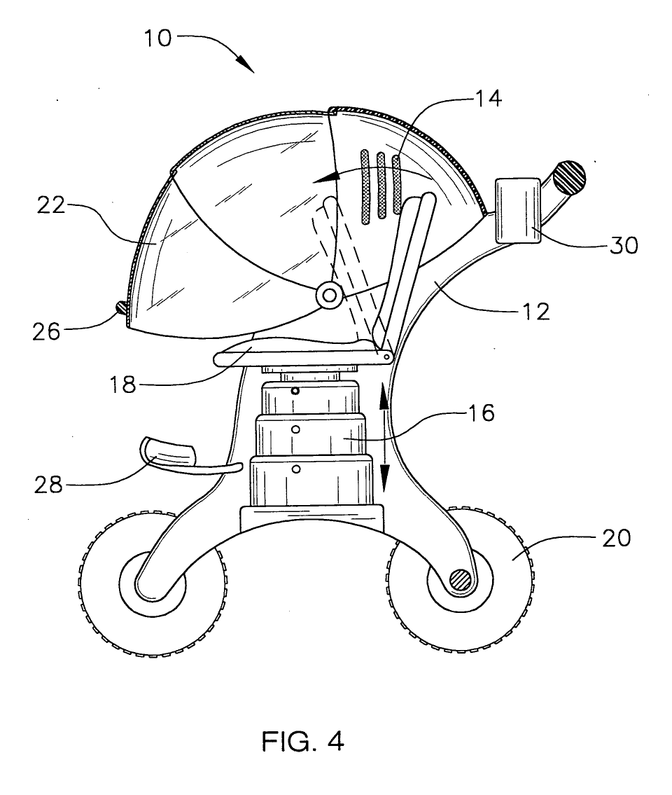

In FIG. 4, the baby stroller is illustrated and will be described. The baby stroller 10 has the frame 12 that has the air vent slot 14 therein. The telescoping seat cylinder 16 is connected to the frame 12, the telescoping seat cylinder 16 is lockable at predetermined lengths. The seat 18 is connected to the telescoping seat cylinder 16. The seat 18 is capable of being tilted. The plurality of wheels 20 are rotatably connected to the frame 12. The oblate spheroid wedge shaped transparent canopy 22 is rotatably connected to the frame 12 for shielding the baby. The handle 26 is connected to the canopy 22 for raising and lowering the canopy 22. The foot rest 28 is connected to the frame 12. The cup holder 30 is attached to the frame 12.

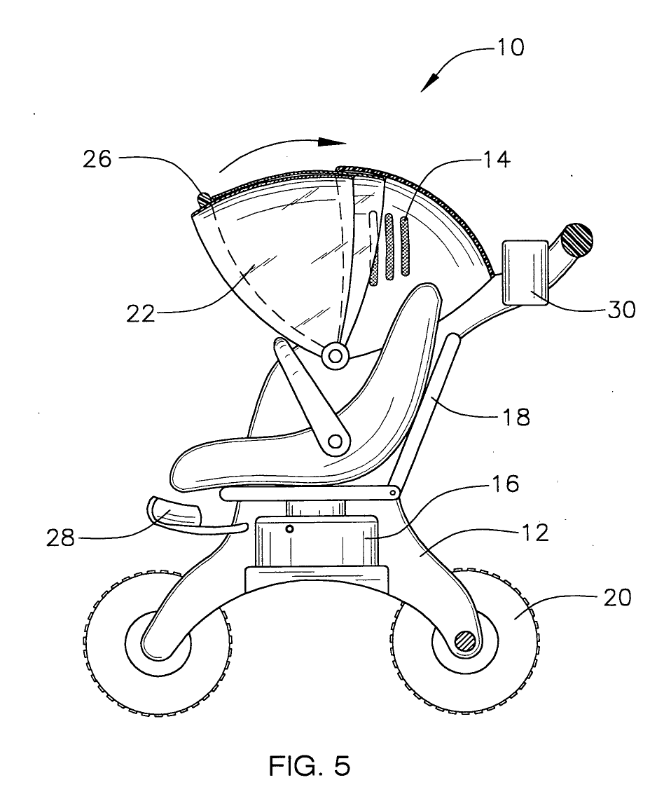

In FIG. 5, the baby stroller is illustrated and will be described. The baby stroller 10 has the frame 12 that has the air vent slot 14 therein. The telescoping seat cylinder 16 is connected to the frame 12, the telescoping seat cylinder 16 is lockable at predetermined lengths. The seat 18 is connected to the telescoping seat cylinder 16. The seat 18 is capable of securely holding the baby carrier. The plurality of wheels 20 are rotatably connected to the frame 12. The oblate spheroid wedge shaped transparent canopy 22 is rotatably connected to the frame 12 for shielding the baby. The handle 26 is connected to the canopy 22 for raising and lowering the canopy 22. The foot rest 28 is connected to the frame 12. The cup holder 30 is attached to the frame 12.

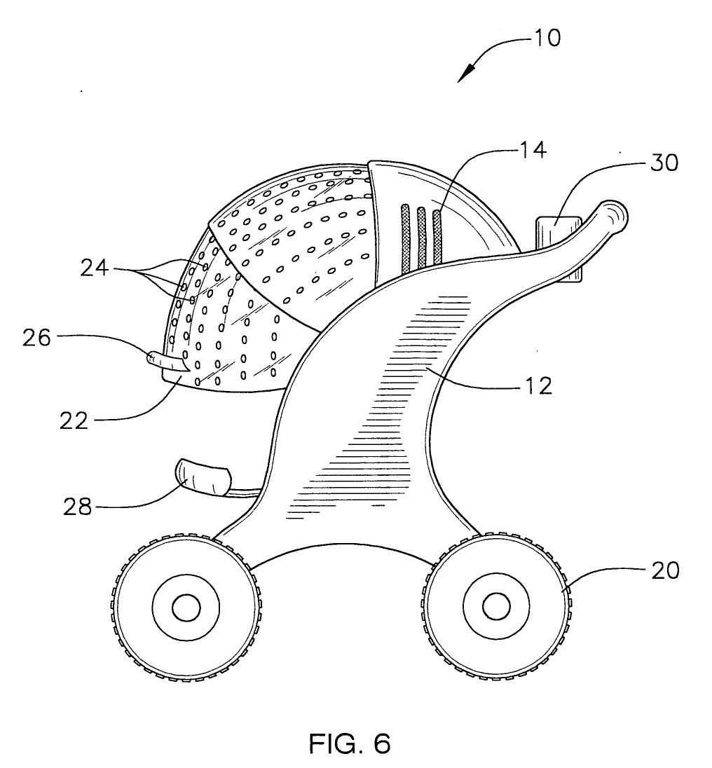

In FIG. 6, the baby stroller is illustrated and will be described. The baby stroller 10 has the frame 12 that has the air vent slot 14 therein. The plurality of wheels 20 are rotatably connected to the frame 12. The oblate spheroid wedge shaped transparent canopy 22 is rotatably connected to the frame 12 for shielding the baby. The canopy 22 has a plurality of vent holes 24 therein. The handle 26 is connected to the canopy 22 for raising and lowering the canopy 22. The foot rest 28 is connected to the frame 12. The cup holder 30 is attached to the frame 12.

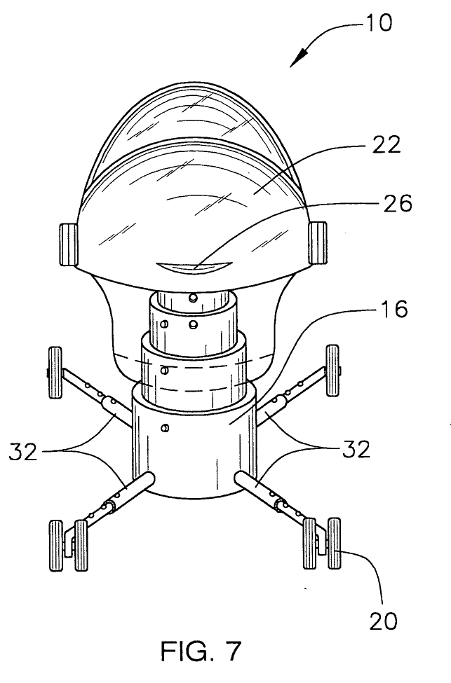

In FIG. 7, the baby stroller is illustrated and will be described. The baby stroller 10 has the frame 12 that has the air vent slot 14 therein. The telescoping seat cylinder 16 is connected to the frame 12, the telescoping seat cylinder 16 is lockable at predetermined lengths. The seat 18 is connected to the telescoping seat cylinder 16. The plurality of wheels 20 are rotatably connected to the frame 12. The wheels 20 are capable of swiveling. The oblate spheroid wedge shaped transparent canopy 22 is rotatably connected to the frame 12 for shielding the baby. A plurality of telescoping legs 32 are rotatably connected to the wheels 20. The telescoping legs 32 are connected to the frame 12. The telescoping legs 32 are lockable at predetermined lengths.

In use, the baby stroller 10 canopy 22 handle 26 is pulled upward and the baby is placed in the seat 18 and the canopy 22 is then lowered into place and used as a conventional baby stroller.

While a preferred embodiment of the baby stroller has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as metal or composite may be used instead of the plastic described. And although baby strollers having a retractable shield have been described, it should be appreciated that the baby stroller herein described is also suitable for baby trailers for bikes.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A baby stroller comprising:
a frame;
a plurality of wheels rotatably connected to said frame;
a seat connected to said frame; and
at least one arcuate transparent canopy rotatably connected to said frame for shielding said baby.

2. The baby stroller of claim 1 further comprising:
at least one telescoping seat cylinder connected to said frame, said telescoping seat cylinder connected to said seat, said telescoping seat cylinder being lockable at predetermined lengths.

3. The baby stroller of claim 1 further comprising:
a plurality of telescoping legs rotatably connected to said wheels, said telescoping legs connected to said frame, said telescoping legs being lockable at predetermined lengths.

4. The baby stroller of claim 1 wherein:
said wheel to frame connection allows said wheel to swivel.

5. The baby stroller of claim 1 wherein:
said seat is capable of being tilted.

6. The baby stroller of claim 1 wherein:
said seat is capable of securely holding a baby carrier.

7. The baby stroller of claim 1 further comprising:
a handle connected to said canopy for raising and lowering said canopy.

8. The baby stroller of claim 1 wherein:
said canopy having vent holes therein.

9. The baby stroller of claim 1 further comprising:
a foot rest connected to said frame.

10. The baby stroller of claim 1 wherein:
said frame having an air vent slot therein.

11. The baby stroller of claim 1 further comprising:
at least one cup holder attached to said frame.

12. A baby stroller comprising:
a frame having an air vent slot therein;
at least one telescoping seat cylinder connected to said frame, said telescoping seat cylinder being lockable at predetermined lengths
a seat connected to said telescoping seat cylinder;
a plurality of wheels rotatably connected to said frame, said wheels capable of swiveling;
at least one oblate spheroid wedge shaped transparent canopy rotatably connected to said frame for shielding said baby; and
a handle connected to said canopy for raising and lowering said canopy.

13. The baby stroller of claim 12 further comprising:
a plurality of telescoping legs rotatably connected to said wheels, said telescoping legs connected to said frame, said telescoping legs being lockable at predetermined lengths.

14. The baby stroller of claim 12 wherein:
said seat is capable of being tilted; and
said seat is capable of securely holding a baby carrier.

15. The baby stroller of claim 12 wherein:
said canopy having a plurality of vent holes therein.

16. The baby stroller of claim 12 further comprising:
a foot rest connected to said frame.

17. The baby stroller of claim 12 further comprising:
at least one cup holder attached to said frame.

18. A baby stroller comprising:
a frame having an air vent slot therein;
at least one telescoping seat cylinder connected to said frame, said telescoping seat cylinder being lockable at predetermined lengths
a seat connected to said telescoping seat cylinder, said seat is capable of being tilted, said seat is capable of securely holding a baby carrier;
a plurality of wheels rotatably connected to said frame, said wheels capable of swiveling;
at least one oblate spheroid wedge shaped transparent canopy rotatably connected to said frame for shielding said baby;
a handle connected to said canopy for raising and lowering said canopy;
a foot rest connected to said frame; and
at least one cup holder attached to said frame.

19. The baby stroller of claim 18 further comprising:
a plurality of telescoping legs rotatably connected to said wheels, said telescoping legs connected to said frame, said telescoping legs being lockable at predetermined lengths.

20. The baby stroller of claim 18 wherein:
said canopy having a plurality of vent holes therein.
